(19) United States
(12) Patent Application Publication
(10) Pub. No.: US 2023/0241818 A1
(43) Pub. Date: Aug. 3, 2023

(54) MANUFACTURING AN ASSEMBLY OF A FIRST AND A SECOND OBJECT

(71) Applicant: WoodWelding AG, Stansstad (CH)

(72) Inventors: Mario Lehmann, Les Pommerats (CH); Jörg Mayer, Niederlenz (CH); Anna Forshufvud, Zürich (CH)

(21) Appl. No.: 18/013,421

(22) PCT Filed: Jun. 30, 2021
(86) PCT No.: PCT/EP2021/068053

§ 371 Date: Dec. 28, 2022

(30) Foreign Application Priority Data
Jul. 3, 2020 (CH) 00826/20

(51) Int. Cl. B29C 45/16; B29C 65/08; B33Y 80/00

(52) U.S. Cl. CPC B29C 45/1657; B29C 65/08; B33Y 80/00; B29C 2045/1659; B29L 2031/7278

(57) ABSTRACT

A method of manufacturing and assembling a first and a second object wherein the first object is made by bringing a flowable compound into a first object shape and then subjecting the flowable compound to a hardening process that results in a change of a chemical composition of the flowable compound, thereby creating the first object or a part thereof. Then, the first object is positioned relative to a second object, and a flow portion of the hardened article of the modified compound is caused to become flowable by an input of energy. An interpenetration zone of the flow portion and structures of the second object is created, and the flow portion is allowed to re-solidify, whereby the interpenetration zone between the re-solidified flow portion and the structures of the second object secures the first and second objects to each other.

### BACKGROUND OF THE INVENTION

### Field of the Invention

The invention is in the field of mechanical engineering and construction and concerns a method of manufacturing an assembly of a first and a second object.

### Description of Related Art

From WO 98/42988 and from WO 00/79137 as well as from WO 2006/002569 or WO 2015/181300 or WO 2018/172 385, which are hereby incorporated by reference in its entirety, methods of anchoring a first object in a second object are taught. The first object includes a thermoplastic material, i.e. a material having thermoplastic properties, in a solid state. For anchoring, the first object is brought into physical contact with the second objects while energy, especially mechanical vibration energy, impinges. Due to the effect of the energy, a flow portion of the thermoplastic material flows into structures of the second object to yield, after re-solidification, an anchoring of the first object in the second object. The structures into which the flow portion flows are primarily structures that are present due to the nature of the second object, which second object may for example be of wood (in which case the structures are formed by irregularities in the wood material), a wood composite, or another artificial material with pores or other irregularities, such as an object with fiber structures etc.

In WO 2016/071 335, which is hereby incorporated by reference it its entirety, a method of anchoring a second object in a first object is taught. In this, the first object includes a thermoplastic material in a solid state, and the second object has coupling structures. The second object is brought into contact with the first object, and mechanical vibration energy is coupled into the second object until the flow portion of the thermoplastic material is liquefied and flows into the coupling structures to yield, after re-solidification, a positive-fit connection by re-solidified thermoplastic material interpenetrating the coupling structures.

Both of these approaches have in common that one of the objects is anchored relative to the other one of the objects. In more concrete terms, one of the objects is anchored in the other object by there being an interpenetration of structures of one object by material of the other object which results in an anchoring effect similar to how a root is anchored. This is primarily a positive-fit connection. The interpenetration of re-solidified material (flow portion of the modified compound) of the first object and material of the second object may cause a securement by mechanical adhesion. This means that the re-solidified material fills voids or pores within the second object. Thus, the first and second object hold together by interlocking. Thereby the size of the voids or pores may vary so that the interlocking phenomena occurs with different length scales. However, it is not excluded that a substance-to-substance bond (chemical adhesion) is generated, maybe in in addition to the interlocking phenomenon, for example by a thermoplastic weld. The material of the first and the second object may form a compound within the interpenetration zone. Covalent bonding or ionic bonding may be formed but also hydrogen bonding may occur.

This kind of bonding has proven to yield a quick-to-manufacture and reliable bond. A possible disadvantage is that one of the first and second objects needs to include thermoplastic material. Thermoplastic parts are generally shaped in high-temperature processes, such as injection molding. Such processes tend to be energy consuming and limit the availability of possible materials, including filling materials, to materials capable of withstanding the process. A further possible disadvantage is that the objects bonded by such a process are not easy to disassemble in a manner that the different materials are clearly separated. This may be a disadvantage for recycling processes.

### SUMMARY OF THE INVENTION

It is an object of the present invention to provide new approaches of manufacturing an assembly of a first and a second object, in which the first and second objects are bonded to each other.

According to a first aspect of the invention, a method of manufacturing an assembly of a first and a second object is provided, which method has two main stages.

In a first stage, the first object is manufactured in a shaping process that may for example especially be a non-thermal shaping process. In this stage, a flowable compound is shaped (cast or extruded) to be in a first object shape. The shaping process may be a casting process, and for example a mold may be used. Then, the compound is subject to a hardening reaction that results in a change of the chemical composition of the flowable compound, whereby a hardened article of a modified compound is created, which article constitutes at least a part of the first object and for example constitutes the entire first object.

The first object shape is the shape the first object or at least a portion thereof has at the onset of the subsequent second stage. Especially, at least the surface of that portion of which in the second stage the flow portion is formed, is defined in the step of bringing the flowable compound into the first object shape, for example by being defined by the mold used. In embodiments in which in the second stage the first object is pressed against the second object, those surface portions of the first object that come into contact with the second object at the onset of pressing may belong to the surface portions of the first object shape.

In embodiments, the shaping process does not include a step of heating the flowable compound or introduction of heat to liquefy the compound to become flowable. The shaping process may especially be a cold transition, i.e. a transition that takes place without the necessity to actively heat the flowable compound or to heat the compound to become flowable, to an elevated temperature. For example, the shaping process may take place at room temperature or at a temperature the compound reaches when the shaping process takes place in a non-heated mold being in an environment that is at room temperature. It is not excluded, though, that due to the shaping process possibly being exothermic or endothermic, the temperature of the compound may become higher or lower than room temperature during the shaping process and as a result thereof.

The modified compound has the property of being liquefiable by a thermal process, i.e. by introducing energy. This property exists in particularly after the shaping process which creates the modified compound but it may additionally exist prior to the shaping process. In embodiments, the compound may be solved by a suitable solvent which is preferably not harmful or toxic and is most preferably water. This means that the compound can be solved before the shaping process to become flowable. Of course, an (additional) solvent may also be used during the shaping process to increase the flowability of the flowable compound.

In a second stage, the first object and a second object are bonded to each other. In this bonding process, a flow portion of the modified compound is reversibly made flowable by input of energy, and in this flowable state an interpenetration zone of the flow portion of the modified compound and structures of the second object is generated.
In a first group of embodiments, the bonding process (second stage) includes causing at least a portion of the energy, and for example the vibrational energy, to impinge on the first object until the flow portion becomes flowable, and causing the flow portion to penetrate into structures of the second object. In this, the first object may be caused to be pressed against a surface of the second object at least locally. The structures into which the flow portion penetrates may include actual or in-situ-made pores of the second object. In the terminology used herein, “pores” is to be understood to include voids in a material of regular or irregular arrangements; this includes voids in irregular arrangements and size distributions as well as voids formed by regular cells. In the first group of embodiments, the first object may for example be a connector. In the first group of embodiments, an overall size (for example overall volume) of the first object may be substantially smaller than an overall size (for example overall volume) of the second object.
In a second group of embodiments, the second object has structures, namely a coupling structure that has an undercut, and/or the second object is capable of being deformed to include such a coupling structure with an undercut. The bonding process includes pressing the second object against the first object while at least a portion of the energy, and for example the vibrational energy, is coupled into the second object. Due to the effect of the energy, the second object is heated at least locally where in contact with the first object, and material of the first object is caused to flow into the structures of the second object. In the second group of embodiments, the second object may for example be a connector. In the second group of embodiments, an overall size (for example overall volume) of the first object may be substantially larger than an overall size (for example overall volume) of the second object.
In a third group of embodiments, the second object has a second thermoplastic material different from the modified compound, wherein a temperature at which the second thermoplastic material becomes flowable is the same as the temperature at which the modified compound becomes flowable or is similar to this temperature—for example by being different by at most 50° C. Due to the effect of the energy, a flow portion of the modified compound as well as a thermoplastic material portion of the second object become flowable, and a heterogeneous mixture of material portions of the first and second objects results, which heterogeneous mixture forms the interpenetration zone. Thereby, the modified compound and the second thermoplastic material are bonded to each other in the interpenetration zone by a positive-fit connection and/or a substance-to-substance bond. The second thermoplastic material may be a second modified compound which may be different from the first modified compound.

Thus, according to the first aspect, a method of manufacturing an assembly of a first and a second object is provided, the method including the steps of:
Providing a flowable compound;
Bringing the flowable compound into a first object shape;
While the flowable compound is in the first object shape, subjecting the flowable compound to a hardening process that results in a change of a chemical composition of the flowable compound, thereby creating a hardened article of a modified compound having the first object shape, which article constitutes at least a part of the first object;
Providing the second object;
Positioning the first object relative to the second object;
Causing a flow portion of the hardened article of the modified compound to become flowable by an input of energy; and generating an interpenetration zone of the flow portion and structures of the second object; and
Allowing the flow portion to re-solidify, whereby the interpenetration zone between the re-solidified flow portion and the structures of the second object secures the first and second objects to each other.

More in general, the last two steps in the above-mentioned method according to the first aspect are:
Causing a flow portion of the hardened article of the modified compound to become flowable by an input of energy; and
Allowing the flow portion to re-solidify, whereby the flow portion secures the first and second objects to each other,
   wherein preferably during the step of causing the flow portion to become flowable, an interpenetration zone of the flow portion and structures of the second object is generated, and as a result of the flow portion being allowed to re-solidify, the interpenetration zone between the re-solidified flow portion and the structures of the second object secures the first and second objects to each other.

As mentioned, for the second stage to be possible, the modified compound has the property of being liquefiable by a thermal process. In this, a thermal process may be a first-order thermodynamic phase transition or a second-order thermodynamic phase transition.

The term “flow portion” as used herein refers to a portion of the first object being made of or including the modified compound. This portion can be liquefied by impinging energy and can re-solidify thereafter when cooling down. In other words, the flow portion is a part of the hardened article of the modified compound which is made flowable for a short time using energy.

In all groups of embodiments, the energy that impinges on the first object may be mechanical vibration energy. The mechanical vibration energy may generate friction between the first and second objects which friction causes a local heating of the first object material where in contact with the second object, whereby the material locally becomes flowable. It is possible also, that the mechanical vibration energy generates internal friction within the first object, for example within the material by Young's complex modulus having an imaginary part being substantially different from zero, and/or at an internal interface between the modified compound and another part of the first object.

Mechanical vibration or oscillation suitable for the method according to the invention may have a frequency between 2 and 200 kHz (especially between 10 and 100 kHz, or between 20 and 40 kHz) and a vibration energy of 0.2 to 20 W per square millimeter of active surface. The vibrating tool (e.g. sonotrode) is e.g. designed such that its contact face oscillates predominantly in the direction of the tool axis (longitudinal vibration) and with an amplitude of between 1 and 100 μm, preferably around 30 to 60 μm. Such preferred vibrations are e.g. produced by ultrasonic devices as e.g. known from ultrasonic welding.

As an alternative to mechanical vibration energy, or in addition thereto, other energy sources are possible, such as other mechanical energy (for example rotation, continuous or oscillating), electromagnetic fields or radiation, conventional resistive heating, heating by a flow of a hot fluid (for example hot air), etc.

In all groups of embodiments, the second stage may include pressing the first and second objects against each other while the energy impinges. For example, if the energy is mechanical vibration energy, a sonotrode may be used to press the first object against the second object or to press the second object against the first object while mechanical vibration energy is coupled from the sonotrode into the first/second object.

In all groups of embodiments, the step of making the flow portion flowable by the input of the energy, the first object, or the part thereof that includes the modified compound, is mostly made flowable only locally, as opposed to a casting process in which the whole article would be liquefied. Such local liquefaction implies that only a portion of the modified compound is liquefied and that the first object keeps its overall shape during the process. Especially, if the energy is mechanical vibration energy, the first object may have an incoupling face against which a sonotrode will be pressed for coupling the vibration energy into the first object, and the first object in a vicinity of this incoupling face may remain solid, the mechanical vibration being transmitted through the first object to the spot or spots where the local liquefaction takes place. To this end, the modified compound may optionally have a modulus of elasticity of at least 0.5 GPa.

The hardening process causing the transition from the flowable compound to the modified compound may include at least one method of the group comprising: removal of a solvent (‘drying’), adsorption, a hydraulic reaction, and a chemical cross-linking. The hardening process may take place without any required input or possibly assisted by energy input, such as by radiation, such as UV radiation or by addition of an initiator molecule, a catalyst or activating agent.

An activating agent may be an unstable chemical compound which produces active species that attack monomers in order to start or to speed up polymerization or it may be a molecule that increases the activity of an enzyme or a protein.

The first stage may include the following steps:
providing or preparing the flowable compound which may be a composition of different components
casting or extruding the flowable compound and
hardening the compound to obtain an article made of a modified compound.

It is preferred that the first stage of the method (including all preparatory steps) or respectively the step of providing or preparing the flowable compound does not include melting the compound to become flowable. Preparation of the flowable compound may include mixing of different components or solving one or more components using a suitable solvent. The flowable compound is then shaped by casting or extruding and subsequently hardened.

The hardening reaction can be chosen from the group consisting of: drying, chemical reaction (transformation), percolation, a hydraulic reaction such as pressuring, or adsorption. The chemical reaction may be a polymerization reaction. It may further include a precipitation. The shaping process may include the change of the chemical composition. This means the chemical composition of the flowable compound is different from the chemical composition of the modified compound. This change can be caused by the loss of a solvent, formation of a reaction product or crystallization. The hardening reaction may be reversible or irreversible and is preferably irreversible. The hardening reaction may be started using catalysts or initiator molecules such as radicals or enzymes (transglutaminases). The flowable compound may be a mixture including a solvent, a binder and a filling material. The mixture (physical combination of two or more substances) may be a suspension, a solution or an emulsion. Preferred is a suspension. A suspension is a heterogeneous mixture in which the solute particles do not dissolve, but get suspended throughout the bulk of the solvent, left floating around freely in the solvent. The solid phase is dispersed throughout the liquid phase (fluid) through mechanical agitation. The use of certain excipients or suspending agents is possible. In addition, the liquid phase may be a solution wherein at least one substance (solute) is dissolved in a solvent. The flowable compound or the mixture thereof may further include additives. Suitable classes of additives are: hygroscopic additives, softening agents, stabilizing agents, active agents, coloring agents (pigments), cross-linking agents, foaming agents and fire retarding agents. All additives are preferably biologically degradable.

Suitable solvents are: water, buffer solutions (containing salts), and organic solvents such as alcohols (preferably ethanol). In many embodiments, water is preferred as a solvent. Another preferred solvent is a deep eutectic solvents and in particular a mixture of choline chloride and a hydrogen bond donor such as urea in a molar ratio from 5:1 to 1:3.

Filling materials are particles added to the flowable compound that can improve specific properties, make the product cheaper, or a mixture of both. Suitable filling materials are: natural fibers, kaolin, talc, hemp, flax and carbon black. In many embodiments, natural fibers are preferred fillers.

The term “natural fiber” as used herein refers to fibers that are produced by plants or animals. Examples of suitable natural fibers are: wood fibers, cellulose fibers, fibers of corn, bamboo fibers, hemp fibers, flax fibers, textile fibers, fibers made of hazelnut shells or cotton. The natural fibers being used may be chemically modified, for example they may be methylated, sulfonated, or acetylated. The preferred fibers are wood fibers. Preferred are fibers gained by recycling of materials (textile fibers) or gained as waste during production of other articles (such as nut shells). At least some of the natural fibers used may be comprised of fungal root structure, referred to as mycelium. Mycelium is comprised of a plurality of branching, thread-like filaments, referred to as hyphae.

The orientation of fibers may impact the properties of the modified compound. In case that natural fibers are used as fillers, the flowable compound may be a biocomposite material. These composites include or consist of a natural fiber in a matrix of a suitable solvent (water) and a binder. The length of the fibers may vary depending on the shape of the first object. It is preferred that the length of the fibers is between 0.1 and 10 mm, further preferred between 2 mm and 8 mm and even further preferred between 3 and 7 mm.

The term “binder” or “binding agent” as used herein refers to any material or substance that holds or draws other materials together to form a cohesive whole. Suitable binders are substances that harden by a chemical or physical process and bind filling agents such as fibers, filler powder and other particles added into it. Examples for suitable binders are glue, adhesive and thickening agents.

The group of preferred binders consist of: bitumen, animal and plant glues, and polymers. Suitable binders are: starch, gelatin, natural sugars, corn sweeteners, natural and synthetic gums such as acacia, sodium alginate, carboxymethylcellulose, polyethylene glycol and waxes. Animal and plant glues are solutions made from plants or animals which are able to build a three-dimensional crosslinking through hardening. The term “animal and plant glue” refers also to solutions containing a binder of animal or plant origin or to binder molecules of animal or plant origin. Suitable animal and plant glues may include proteins such as gluten, collagen, gelatin, alginate, albumin, chondrin, fibrin, casein, fibronectin, laminin, entactin, natural resins (such as shellac), glue proteins from shell, snail or velvet worm slime. Protein glues are preferred binders. Denaturation of the proteins should be avoided; therefore, temperature during hardening processes should not be higher than 50° C.

The term “hygroscopic additives” as used herein refers to any material or substance that are able to attract and hold water molecules via either absorption or adsorption from the surrounding environment, which is usually at room temperature. Suitable hygroscopic additives are: hygroscopic polymers such as cellulose or hygroscopic salts (including calcium chloride, magnesium chloride, zinc chloride, ferric chloride, carnallite, potassium carbonate, potassium phosphate, potassium alum, ferric ammonium citrate, ammonium nitrate, potassium hydroxide, and sodium hydroxide. Preferred are hygroscopic salts such as calcium sulfate, magnesium sulfate. These may be added to the flowable compound or during preparation of the flowable compound as powder.

Softening agents suitable to be used within the flowable compound are: glycerin, urea, sorbitol, citrate, zeolite and xanthan. A stabilizing agent is an agent that is used to prevent degradation. Stabilizing agents suitable to be sued within the flowable compound are: lignin sulfonate, linseed oil, and compounds based on calcium (calcium-zinc and organo-calcium). Foaming agents can be used to introduce spaces (chambers, pores or pinholes) filled with gas. This results in a modified material having insulating features (heat and/or sound).

The modified compound should become flowable by the input of energy and preferably pliable or moldable at a certain elevated temperature and (re-)solidifies upon cooling. It is further desirable that the hardened article of the modified compound has a good mechanical stability (is dimensionally stable). Further desirable features are: biodegradable, environmentally compatible, recyclable and sustainable. “biodegradable” may mean biodegradable in accordance with European standard EN13432 (as of the end of 2019). In one embodiment the modified compound does not include a plastic (synthetic or semi-synthetic organic compound).

A preferred embodiment of the invention refers to a process or a product obtained by a method as described herein, wherein the flowable compound includes or is obtained by mixing together:
10-60% per weight of a binder,
5-50% per weight of a filling material,
2-50% per weight of an additive, and
up to 83% per weight of a solvent. Of course, the maximal amount of each component is chosen to reach 100% per weight in total.

A preferred embodiment of the invention refers to a process, wherein the flowable compound includes or is obtained by mixing together:
10-60% per weight of the binder,
5-50% per weight of the filling material,
2-15% per weight of a hygroscopic agent,
2-40% per weight of another additive, and
up to 81% per weight of the solvent.

Another preferred embodiment of the invention refers to a process, wherein the flowable compound includes or is obtained by mixing together:
20-40% per weight of a protein as binder,
10-25% per weight of wood fibres as filling material,
5-10% per weight of a hygroscopic agent, and
15-55% per weight of a solvent.

Another preferred embodiment of the invention refers to a process, wherein the flowable compound includes or is obtained by mixing together:
10-40% per weight of a protein as binder,
5-30% per weight of natural fibres as filling material,
2-15% per weight of a hygroscopic salt,
2-10% per weight of other additives, and
5-81% per weight of a solvent.

Another preferred embodiment of the invention refers to a process, wherein the flowable compound includes or is obtained by mixing together:
10-40% per weight of the binder,
5-30% per weight of the filling material,
2-15% per weight of a hygroscopic salt,
2-10% per weight of another additive, and
5-81% per weight of a solvent.

It has been found that the material described in EP 2 836 558 B 1, which is hereby incorporated by reference it its entirety, is very well suited for the processes described herein. The inventors have observed that there are significant improvements by keeping the pH of the flowable compound in the range of 6≤pH≤8.5. Improvements observed are an increased stability/durability of the modified compound. Operating in the pH range of 6≤pH≤8.5 can also improve adhesion between the first and second object. These flowable compounds suitable for the methods according to the invention are safe to handle and easy to manufacture.

Examples of compositions suitable as flowable compound are:
10-60% (preferably 30-50%) per weight of lignin or lignin salts as binder,
5-50% (preferably 20-40%) per weight of natural fibers as filling material
2-10% per weight of an additive, and
up to 83% per weight of a solvent.

Of course, the maximal amount of each component is chosen to reach 100% per weight in total. The preferred solvent is water or a mixture of water and ethanol. Suitable natural fibers can be chosen from the group of hemp, flax, kenaf, sisal, coconut, ramie, miscanthus, nettle, cotton, cellulose, wool or in general animal hair, palm, reed and wood fibers. The natural fibers may be in the form of short cut and/or be admixed in particulate to flour-like consistency and in particular have dimensions between about 10 μm and 10 mm. Useful additives may be fatty acid salts. The additive may also be a thermoplastic polymer. This thermoplastic polymer can be biodegradable. It is preferred that the thermoplastic polymer used as additive has an elongation at break of >10 respectively >50% (ISO 527; 50 mm/min). Examples for suitable thermoplastic polymers are ε-caprolactone and polyhydroxy valerate. The amount of thermoplastic polymer within the modified compound are preferably between 10-30% per weight. The thermoplastic polymer may be added during the step “Subjecting the flowable compound to a hardening process that results in a change of a chemical composition of the flowable compound, thereby creating a modified compound” or during the step “Subjecting the modified compound to a thermal shaping process to create a hardened article of the modified compound, which article constitutes at least a part of the first object”. It may further be added in an additional compounding step after the step “Subjecting the modified compound to a thermal shaping process to create a hardened article of the modified compound, which article constitutes at least a part of the first object”. Addition of the thermoplastic polymer may also be done during the step” While the flowable compound is in the first object shape, subjecting the flowable compound to a hardening process that results in a change of a chemical composition of the flowable compound, thereby creating a hardened article of a modified compound having the first object shape, which article constitutes at least a part of the first object”. In general, an (additional) additive can be combined with the flowable compound or the other components of the flowable compound within the first stage or between the first stage and the second stage of the methods described herein. It may be added during the shaping process, between the shaping process and the hardening process or during the hardening process.

The term “lignin” refers to a class of complex organic polymers that form key structural materials in many plants and consist of highly heterogeneous polymer derived from precursor lignols that crosslink. The lignols derive from phenylpropane and are: coniferyl alcohol, sinapyl alcohol, and paracoumaryl alcohol. Therefore, the term “lignin” as used herein refers to artificially made polymers made of lignols as well as native lignins being extracted from plants. Thus, lignin can be native lignin (primarily kraft, but also alkali based or hot-water-extracted lignin or organosolv lignin or a chemically modified lignin (e.g., acetylated, hydroxypropylated or palmitated). The lignin can be obtained by separating it from various biomasses, particularly from the pulps of the paper industry. Suitable lignin salts are lignosulfonates, or sulfonated lignin. Another derivative of lignin suitable is lignin esterified with oil fatty acids.

Alternatively, a mixture of lignin and tannin may be used as binder within the above composition. The tannin content in the composition may be up to 15% per weight. According to a second aspect of the invention, a method of manufacturing an assembly of a first and a second object is provided, which method has two main stages.

In this, the first stage has two sub-stages. In a first sub-stage, firstly a flowable compound is provided. The flowable compound may have the properties of any flowable compound discussed hereinbefore. Then, the flowable compound is subjected to a hardening process that results in a change of a chemical composition of the flowable compound, whereby, similar to the first aspect, the modified compound is created. In contrast to the first aspect, however, this is not done in a defined shape of the first object (no casting) but in an arbitrary shape, and the modified component is brought into a state in which it is solid but easy to transport and to dose—especially a granulate or powder.

Then, in a second sub-stage, the modified compound is subject to a thermal shaping process to create the hardened article that is the first object or a part thereof. For the subsequent second step, the same considerations apply as for the first aspect. In one embodiment, the first stage process may consist of a first sub-stage including extruding of the flowable compound. Thereby the flowable compound is pushed through a die of the desired cross-section. Subsequently, the extrudate is hardened to the modified compound. The modified compound can be cut into granulate, which is then in the second sub-stage a substrate for manufacturing of a first object or an article being part of a first object.

Thus, according to the second aspect, a method of manufacturing an assembly of a first and a second object is provided, the method including the steps of:
Providing a flowable compound;
Subjecting the flowable compound to a hardening process that results in a change of a chemical composition of the flowable compound, thereby creating a modified compound;
Subjecting the modified compound to a thermal shaping process to create a hardened article of the modified compound, which article constitutes at least a part of the first object;
Providing the second object;
Positioning the first object relative to the second object;
Causing a flow portion of the modified compound to become flowable by an input of energy; and generating an interpenetration zone of the flow portion and structures of the second object; and
Allowing the flow portion to re-solidify, whereby the interpenetration zone between the re-solidified flow portion and the structures of the second object secures the first and second objects to each other.

More in general, the last two steps in the above-mentioned method according to the first aspect are:
Causing a flow portion of the hardened article made of the modified compound and being at least a part of the first object to become flowable by an input of energy; and
Allowing the flow portion to re-solidify, whereby the flow portion secures the first and second objects to each other,
   wherein preferably in the step of causing the flow portion to become flowable, an interpenetration zone of the flow portion and structures of the second object is generated, and as a result of the flow portion being allowed to re-solidify, the interpenetration zone between the re-solidified flow portion and the structures of the second object secures the first and second objects to each other.

While the method according to its second aspect requires a thermal shaping process some advantages of the first aspect are still present, including the possibility of using environmentally friendly compositions for the flowable compound/the modified compound made therefrom. In addition, the second aspect enjoys the advantages of conventional thermal shaping processes, such as established processes for mass manufacturing etc.

The thermal shaping process may especially be an injection moulding process or other moulding process taking place with the liquefied modified compound.

As an alternative, to being a moulding process, the thermal shaping process may be an additive manufacturing process, i.e. a so-called “3D-printing” process.

The above considerations referring to the first aspect and referring to the composition and properties of the flowable compound and the hardening process equally apply to the second aspect. Also, the considerations concerning the second apply to both, the first aspect and the second aspect.

The following applies to both aspects: The first object may consist of the modified compound, for example by the shaped article constituting the first object.

The second object in the first group of embodiments includes a material/material composition that does not liquefy at temperatures at which the modified compound becomes flowable. It may be of a penetrable material that is solid at least under the conditions of the second stage, wherein “solid” in this context may mean that this material is rigid, substantially not elastically flexible (no elastomer characteristics) and not plastically deformable and it is not or only very little elastically compressible. It may further include (actual or potential) spaces into which the liquefied material can flow or be pressed for the anchoring. In addition, or as an alternative, the penetrable material may be capable of developing such spaces under the hydrostatic pressure of the liquefied thermoplastic material. This property (having potential spaces for penetration) implies e.g. inhomogeneity in terms of mechanical resistance. An example of a material that has this property is a porous material whose pores are filled with a material which can be forced out of the pores, a composite of a soft material and a hard material or a heterogeneous material (such as wood) in which the interfacial adhesion between the constituents is smaller than the force exerted by the penetrating liquefied material. Thus, in general, the penetrable material includes an inhomogeneity in terms of structure (“empty” spaces such as pores, cavities etc.) or in terms of material composition (displaceable material or separable materials). The structures of the second object into which the liquefied material of the first object flows may be cells of a foam. Thus, in one embodiment of the invention the second object is made of or includes a foam. A foam is understood to be a material formed by trapping pockets of gas in a liquid or solid. Examples for foams suitable are: Expanded polystyrene (EPS), polystyrene foams, foams made of biopolymers such as wheat gluten/TEOS foams, or a metal foam. In another embodiment the second object or the structures of the second object into which the liquefied material of the first object flows may be made of paper or cardboard materials such as pressed paper, stacked paper, kraft board, container board, laminated board and corrugated fiberboard. Thus, the methods of the invention may be used to connect or clue two objects (second object and third object) made of paper or cardboard. It may also be used to fix an insulating material such as wool or flax (second or respectively third object) to wood or a material made of paper or cardboard (second or respectively third object). Therefore, the first object has at least two flow portions, which can be attached to the second and the third object and connect them.

More in general, for the first group of embodiments, the material of the second object is solid and is penetrable by the modified compound when the latter is in a liquefied state (i.e. the respective first/second object materials are fibrous or porous, includes penetrable surface structures or cannot fully resist such penetration under pressure).

Especially, the material of the second object for the first group of embodiments is not only solid at ambient temperature, but is such that do not melt, at least not to a substantial degree, under the conditions that apply when the first material penetrates the surface structures.

In the second group of embodiments, the second object is of a material that is not liquefiable under the conditions that are present during the first stage. Especially, the second object is not liquefiable at a temperature at which the modified compound becomes flowable. In this text “non-liquefiable” means “not liquefiable under the conditions that apply during the process”. In this text, therefore, generally a “non-liquefiable” material is a material that does not liquefy at temperatures reached during the process (and also not at temperatures being lower), thus especially at temperatures at which the flow portion of the modified compound is liquefied. This does not exclude the possibility that the non-liquefiable material would be capable of liquefying at temperatures that are not reached during the process, generally far (for example by at least 50° or at least 80° C.) above a liquefaction temperature of the thermoplastic material or thermoplastic materials liquefied during the process. The liquefaction temperature is the melting temperature for crystalline materials, including crystalline polymers. For amorphous thermoplastics the liquefaction temperature (also called “temperature at which the material becomes flowable”) is a temperature above the glass transition temperature at which the material becomes sufficiently flowable, sometimes referred to as the ‘flow temperature’ (sometimes defined as the lowest temperature at which extrusion is possible), for example the temperature at which the viscosity drops to below 10⁴ Pa*s (in embodiments, especially with polymers substantially without fiber reinforcement, to below 10³ Pa*s)), of the thermoplastic material or the modified compound.

Applications of the methods described herein include the production of furniture, both, flat-pack furniture (i.e., pieces of furniture to be assembled by the user) as well as pre-assembled furniture. Further uses include the building industry, for example manufacturing of doors, window frames, etc., as well as manufacturing caravans and RVs. Other applications, such as in the car manufacturing industry or other industry are possible, too.

The invention also concerns the use of a material (the flowable compound) as described in this text for manufacturing a connector or an object in which a connector is anchored, which connector or object is suitable for a securing process in which the processed flowable compound serves as the modified compound and is, by the input of energy, locally made flowable to interpenetrate structures of an object to which the connector is secured or to interpenetrate structures of a connector secured to the object, respectively.

The invention moreover concerns a connector manufactured from a material (flowable compound) as described in this text. The connector may for example include at least one energy directing feature of the material, for example a tip or a rib. Such energy directing feature assists the local liquefaction of the material during the securing process, which corresponds to the second stage of the methods described hereinbefore. The first object may comprise, in addition to the modified compound material, a portion of a different material, for example a material that is not liquefiable or liquefiable only at a substantially higher temperature (for example higher by at least 50°) than the modified compound. Such additional portion may for example be a core, e.g. including at least one of natural fibers, wood, a biodegradable material, a metal, ceramic material, a thermosetting polymer or any combination thereof. It may make the first object more stable, for example with respect to absorbing shear forces between the first and second objects.

The connector as mentioned herein may be any device suitable for connecting one object to another. In one embodiment the first object is a connector suitable to connect a third object to the second object. The connector may be an anchor, a pin, a dowel, a nail or a bolt. It may have a screw thread or ribs. The flow portion of the first object or the connector which may consist of the modified compound may be a portion of the shell surface of the first object or respectively the connector. It may further be a core which can flow through holes within a sleeve surrounding the flow portion. The connector may also include two flow portions made of the same or different modified compound. In case the modified compound differs, it is preferred that the modified compound has different liquefaction temperatures. Two flow portions allow to secure the connector to a second object and thereafter connecting to the second object performing a method as described herein. Thereafter, a third object may be connected to the second object via the second flow portion of the connector.

The reinforcement element as mentioned herein may be any device suitable for reinforcing, augment or strengthening another object. The reinforcement element can be used to fill at least some of the pores of the second object with the material of the modified compound and thus, reinforce the second object. Thereby the reinforcement may be locally limited. The reinforcement element can have the shape of a pin, a dowel, or a bolt. It may have a screw thread or ribs. The flow portion of the first object or the reinforcement element which may consist of the modified compound may be a portion of the shell surface of the first object or respectively the reinforcement element. It may further be a core which can flow through holes within a sleeve surrounding the flow portion. Thereafter, a third object may be connected to the second object within the reinforced area of the second object.

The invention also concerns a method for making a connector or reinforcement element including the step:
mixing together:
   10-60% per weight of a binder,
   5-50% per weight of a filling material,
   2-50% per weight of an additive, and
   up to 83% per weight of a solvent.

The considerations made above and referring to the composition and properties of the flowable compound and the mixing step equally apply to said method. Thus, the method may include a hardening process.

### BRIEF DESCRIPTION OF THE DRAWINGS

The invention and embodiments thereof are described in further detail in connection with the appended drawings that are all schematical. Same reference numbers refer to same or analogous elements. In the drawings:

FIGS. 1-4 illustrate steps of the first stage of a method according to the first aspect, the manufactured first object being a connector;

FIGS. 5-7 depict the second stage for an example of the first, second, and third group of embodiments, respectively;

FIG. 8 shows a detail of an interface produced in accordance with FIG. 7;

FIGS. 9 and 10 show steps of the first stage of a method according to the second aspect; and

FIG. 11 shows a combined first stage/second stage of a method according to its second aspect.

FIGS. 12A-12C show a second stage of a method wherein the first object is a reinforcement element.

FIGS. 13A-13C show a second stage of a method wherein the first object is a connector having two flow portions.

### DESCRIPTION OF PREFERRED EMBODIMENTS

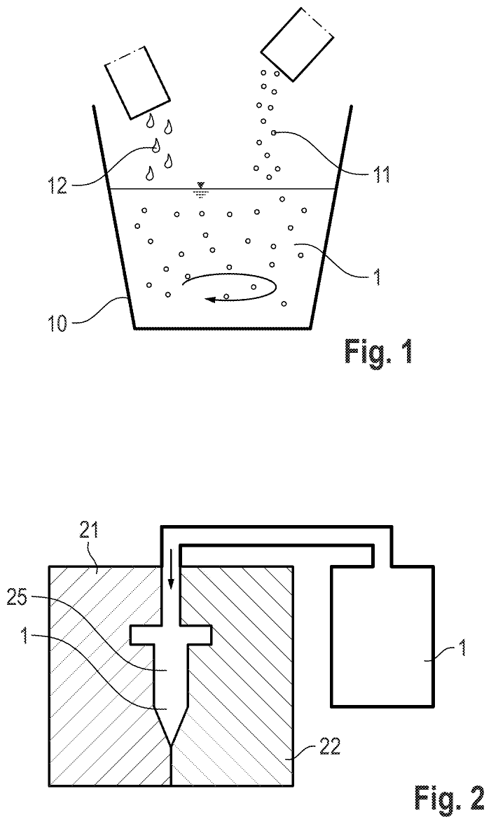

FIG. 1 illustrates the step of composing the flowable compound 1. Liquid constituents 12 and possibly solid constituents 11 (see the description of the material above) are illustrated to be mixed in a vessel 10 until a desired composition is achieved, for example with desired parameters such as viscosity, temperature etc.

In FIG. 2, a quantity of the flowable compound 1 is filled into a cavity 25 of a mold. The mold is illustrated to have two mold halves 21, 22.

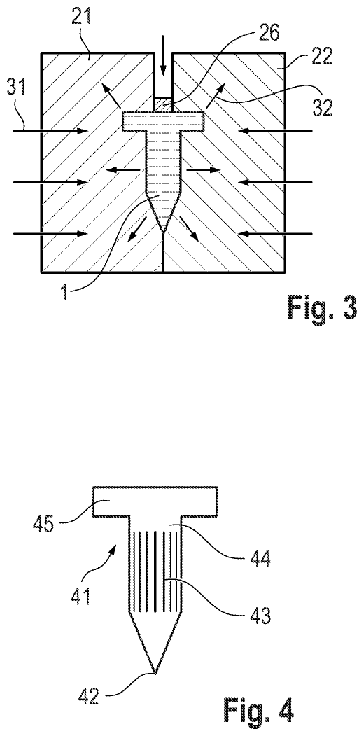

FIG. 3 very schematically illustrates the hardening process. During this process, the flowable compound 1 remains in the cavity 25, which cavity is for example completely closed (closure 26). The hardening process may optionally include material removal (arrows 32) for example if the hardening process includes drying, such as allowing a solvent to diffuse into the mold, which then has the necessary absorbing capacity, for example by being porous. The hardening process may in addition or as an alternative include that energy impinges, such as for example in the form of UV irradiation (arrows 31). It is not excluded that the process may include material reception, for example by an initiator or similar being supplied via the mold.

The hardening process results in the first object (or an article supplemented by a further constituent to become the first object) being manufactured. FIG. 4 illustrates an example of the first object 41. The first object is a connector having a connector shaft portion 44 and a connector head portion 45, whereby the shaft portion (or at least a distal (in FIG. 4 lower) part thereof may be anchored in the second object, while a further object is secured to the second object. If the connector has the shape illustrated in FIG. 4, such further object may have a sheet-like or plate-like portion with a through hole through which the shaft extends, so that the sheet-like or plat-like portion is clamped between a proximal (upper) surface of the second object and a distal (lower) surface of the head portion—similar to a screw with a screwhead or nail with a nail head securing an item to a wall.

Other shapes of connectors, including connectors with another dedicated connecting structure, such as an inner or outer thread, an undercut coupling structure etc. are readily possible.

The first object 41 of FIG. 4 has energy directing structures for the subsequent second stage. The energy directing structures include a distal tip 42 as well as a plurality of ribs 43 which are illustrated to extend axially along an outer surface of the shaft portion 44.

In FIGS. 2-4, the first object 41 is illustrated to be cast of the flowable compound and to consist of it. It would be possible also that the first object in addition to having portions of the flowable compound also has portions of a further constituent. For example, a constituent of a different material, for example of a metal, may be placed in a defined position in the mould cavity during the casting process, and/or a constituent of a different material may be affixed to the moulded article after the hardening process to yield the first object.

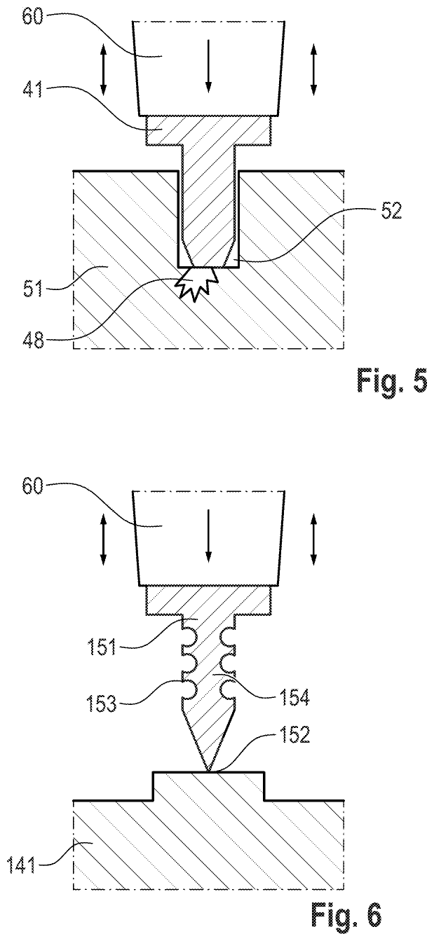

FIG. 5 illustrates the second stage for an example of the first group of embodiments. The first object 41 of the kind illustrated in FIG. 4 is shown together with an example of a second object 51, which second object has a proximally facing surface and an opening 52 being a blind hole, the opening having a mouth in the proximally facing surface. The second object is, at least in a vicinity of the opening, of a material that is penetrable by the flow portion in the above-described sense. An example of a material of the first object is a wood or wood composite.

For securing, the first object 41 is placed relative to the second object 51, with the shaft portion partially inserted in the opening 52. Then, a sonotrode 60 is used to press the first object 41 against the second object 51 while mechanical vibration energy is coupled into the first object 41 via a proximally facing coupling-in face (upper surface in the figure) of the first object 41 until a flow portion 48 of the modified compound becomes flowable and flows into structures of the second object to yield, after re-solidification, an anchoring of the first object in the second object.

The second stage may be substantially as described in WO 98/42988 (for example as described referring to FIGS. 1-4) or in WO 00/79137 (then possibly without the opening 52; for example based on the principle as described referring to FIG. 1) or in WO 2006/002569 (then with the energy impinging indirectly on the first object, via a further object to be connected to the second object, for example substantially as described referring to FIGS. 1-11) or in WO 2015/181300 (then with the shaft portion and the opening adapted to each other for a press-fit; as described for example referring to FIGS. 1 and 5) or in WO 2008/034276 (then for example with an additional counter element being used, for example as described referring to FIG. 4). Other possibilities include the possibility causing the flow portion to be made flowable not in direct contact between the first and second objects and due to friction between these objects but in contact between the sonotrode and/or a counter element and the modified compound, for example as described in WO 2009/052644, for example as described referring to FIG. 1 or FIG. 3 or FIG. 5. An even further variant is shown in WO 2018/172 385 where the second object in a region has a material of low density which is penetrated and possibly compressed by the first object—for example a fibrous material. All these documents mentioned above are incorporated herein by reference.

FIG. 6 illustrates an example of the second group of embodiments. The first object 141 shaped in the first stage and including the modified compound is a functional part having a structure dictated by its function. The second object 151 is for example a connector and is of a material that does not liquefy at the temperature at which the modified compound becomes flowable.

The second object 151 is illustrated to have a head portion and a shaft portion 154 for a similar function as the connector constituting the first object in the previous embodiment. The second object moreover has pre-made structures 153—here illustrated to include recesses along the shaft portion—into which the flow portion can flow during the second stage.

For seconding, a sonotrode 60 is used to press the second object 151 against the first object 141 while mechanical vibration energy is coupled into the second object 151 until a portion of the second object penetrates into material of the first object 141 and causes a flow portion thereof to become flowable and flow into the pre-made structures 153. With respect to the direction in which the second object is pressed relative to the first object, the structures form an undercut, so that the re-solidified modified compound secures the first and second objects to each other by a positive-fit connection.

In embodiments of the second group, the second stage and/or the structure or shape of the second object may be substantially as described in WO 2016/071335, which is incorporated herein by reference.

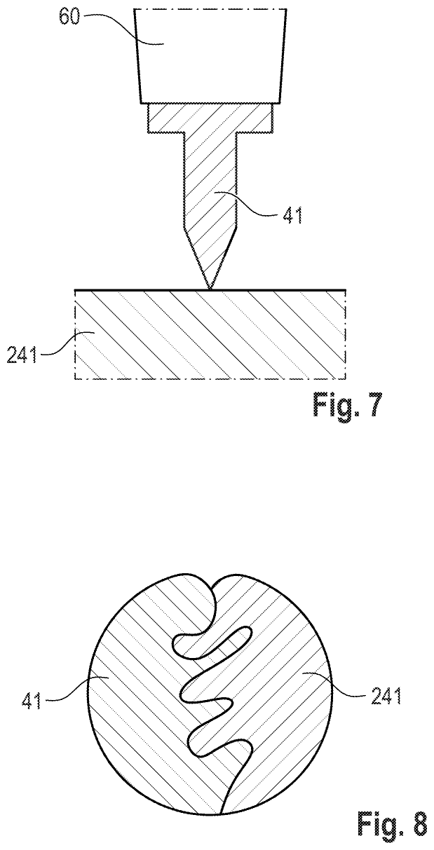

FIG. 7 shows an example of the third group of embodiments. In FIG. 7, the first object 41 is illustrated to be similar to the first object of FIG. 5. The second object 241 is a thermoplastic part having a shape and structure dictated by its function.

For securing, a sonotrode 60 is used to press the first object against the second object while mechanical vibration is coupled into the first object, until a flow portion of the modified compound as well as a thermoplastic material portion of the second object become flowable, and a heterogeneous mixture of material portions of the first and second objects results so that after re-solidification, an anchoring of the first object in the second object is achieved. FIG. 8 very schematically illustrates the according interface.

In embodiments of the third group, the roles of the first and second objects may be interchanged, i.e. it is possible to provide the second object (having the for example conventional thermoplastic material) as a connector and the first object (having the modified compound) to be a functional part, and to cause the vibration energy to impinge on the second object instead of on the first object.

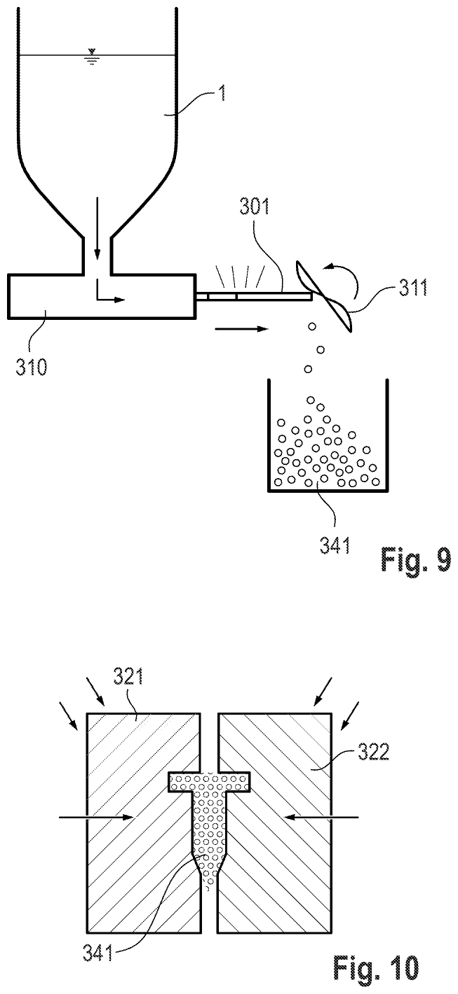

FIG. 9, again very schematically, illustrates the principle of the first stage of the method according to its second aspect. A flowable compound 1 is composed as in FIG. 1 and is then used to prepare a granulate of the modified compound. In the illustrated embodiment, the flowable compound 1 is conveyed in an extruder 310, and then an extruded portion 301 is subject to the hardening process, where after a mechanical device—here schematically illustrated to be a rotating knife 311—is used to hackle the extruded and hardened modified article of the modified compound to yield the granulate 341. The skilled person will readily come up with alternative set-ups producing a granulate or powder used for the second sub-stage. It is possible that some additives, such as common biodegradable polymers, can be added to the flowable compound being within the extruder.

Then, in a second sub-stage, illustrated in FIG. 10, the article constituting the first object or a part thereof is manufactured in a thermomechanical process. Such thermomechanical process may be an injection moulding process, in which the granulate or powder is first molten and then introduced into a cavity of a mould in a flowable state. FIG. 10 illustrates an alternative in which the granulate 341 is initially solid and melting takes place due to heat input on the mould halves 321, 322 while at the same time a pressing force is used to close the mould. The article constituting the first object can be blended with another component such as another thermoplastic polymer or another modified compound. The amount of the added component can be up to 50% but is preferably in the range of 10 to 30%.

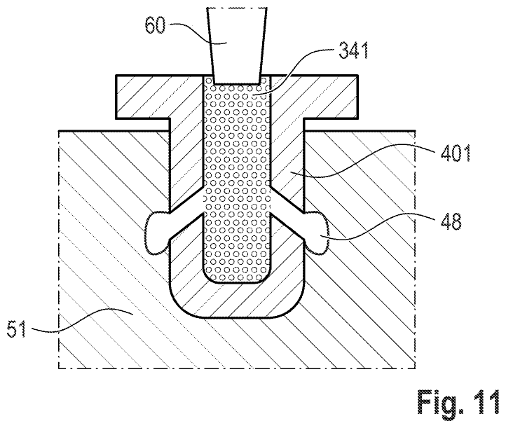

FIG. 11, finally, illustrates a special embodiment of the second aspect, in which the article is shaped in situ during the securing step. The first object includes a sheath 401 of a material not liquefiable at temperatures at which the modified compound becomes flowable. It is placed relative to the second object 51 (which may have a configuration similar to the first group of embodiments of the first aspect described above), and then serves as a vessel for the granulate. The vessel is accessible from proximally, and a sonotrode 60 is used to couple mechanical vibration energy into the granulate, which at the same time is shaped to at least partially fill the vessel and is pressed through holes into the surrounding material of the second object (flow portion 48) to yield the anchoring.

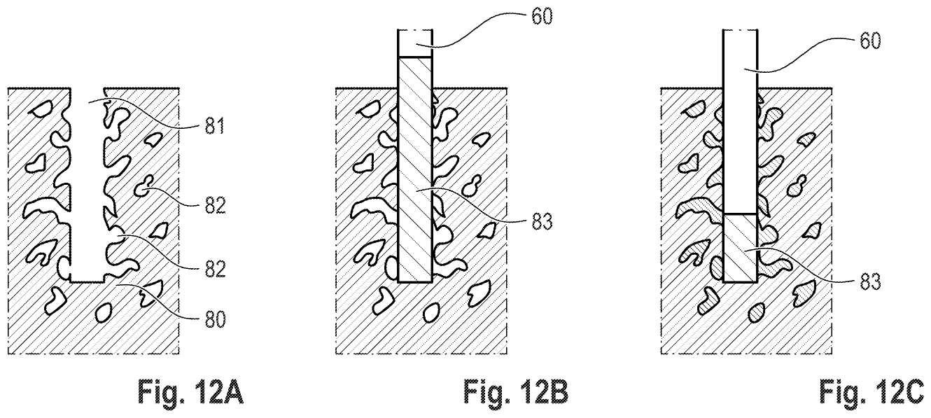

FIGS. 12A-12C show the second stage an embodiment wherein the first object is a reinforcement element. FIG. 12A shows a schematic drawing of a second object 80 having pores 82 and a hole 81 wherein another object should be fixed. FIGS. 12B and 12C outline the steps of reinforcement of object 80. Therefore, a reinforcement element 83 made of a modified compound is introduced into the hole 81. A sonotrode 60 is used to liquefy the material of the reinforcement element. This material flows into the pores of object 2 causing a reinforcement of object 2 within the vicinity of the hole. Subsequently a third object may be anchored to object 2 within the hole.

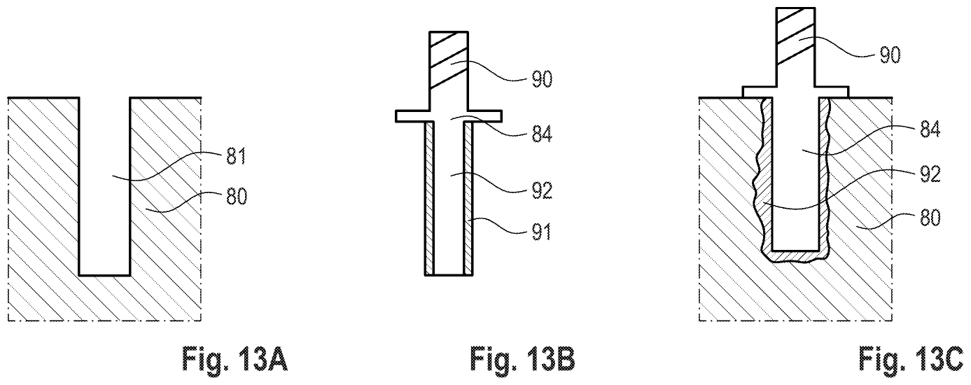

FIGS. 13A-13C show the aspect that the first object is part of a connector having two flow portions and being designed in a way suitable for connecting two objects (a second object and a third object). FIG. 13A shows a schematic drawing of a second object 80 having pores and a hole 81. FIG. 13B shows a connector 84 having a first portion 92 being made of the modified compound. This first portion may have the shape of a pin. The outermost part 91 of this first region can serve as a flow portion. The connector contains a second portion 90 which is also made of a modified compound which may be identical to the material of the first region 92. The second region may have a thread and/or may have a second flow portion. FIG. 13C shows the connector 84 after fixation within the second object 80. The flow portion 91 has been liquefied, penetrated into the second object 80 and was re-solidified. Thus, a penetration zone 92 can be created. The connector 84 is not fixed to the second object 80. The second portion 90 of the connector can be used to attach or secure a third object to the connector and to the second object.

The invention is not restricted to these embodiments. Other variants will be obvious for the person skilled in the art and are considered to lie within the scope of the invention as formulated in the following claims. Individual features described in all parts of the above specification, particularly with respect to the figures may be combined with each other to form other embodiments and/or applied mutatis mutandis to what is described in the claims and to the rest of the description, even if the features are described in respect to or in combination with other features.

1. A method of manufacturing an assembly of a first and a second object, the method comprising the steps of:
providing a flowable compound;
subjecting the flowable compound to a hardening process that results in a change of a chemical composition of the flowable compound, thereby creating a modified compound;
subjecting the modified compound to a thermal shaping process to create a hardened article of the modified compound, which article constitutes at least a part of the first object;
providing the second object;
positioning the first object relative to the second object, the second object is optionally also formed from the flowable compound;
causing a flow portion of the modified compound to become flowable by an input of energy; and generating an interpenetration zone of the flow portion and structures of the second object; and
allowing the flow portion to re-solidify, whereby the interpenetration zone between the re-solidified flow portion and the structures of the second object secures the first and second objects to each other.

2. The method according to claim 1, wherein prior to the thermal shaping process, the modified compound is provided as a granulate or powder.

3. The method according to claim 1, wherein the thermal shaping process is a thermomechanical process.

4. The method according to claim 3, wherein the thermal shaping process is an injection molding or additive manufacturing process.

5. A method of manufacturing an assembly of a first and a second object, the method comprising the steps of:
providing a flowable compound;
bringing the flowable compound into a first object shape;
while the flowable compound is in the first object shape, subjecting the flowable compound to a hardening process that results in a change of a chemical composition of the flowable compound, thereby creating a hardened article of a modified compound having the first object shape, said hardened article constituting at least a part of the first object;
providing the second object, the second object being formed from the flowable compound;
positioning the first object relative to the second object;
causing a flow portion of the hardened article of the modified compound to become flowable by an input of energy, and generating an interpenetration zone of the flow portion and structures of the second object; and
allowing the flow portion to re-solidify, whereby the interpenetration zone between the re-solidified flow portion and the structures of the second object secures the first and second objects to each other.

6. The method according to claim 5, wherein the step of bringing the flowable compound into the first object shape comprises filling the flowable compound into a cavity in a mold, the cavity at least partially having the first object shape.

7. The method according to claim 5, wherein the step of bringing the flowable compound into the first object shape comprises casting, or molding, 3D printing.

8. The method according to claim 1, wherein in the step of causing the flow portion to become flowable by the input of energy, portions of the modified compound remain solid.

9. The method according to claim 8, wherein the portions remaining solid constitute more than 50% of the modified compound.

10. The method according to claim 1, wherein in the step of causing the flow portion to become flowable by the input of energy, only a local flow of material is caused and the first object essentially keeps its shape.

11. The method according to claim 1, wherein the energy is mechanical vibration energy.

12. The method according to claim 1, wherein the energy is electromagnetic energy.

13. The method according to claim 1, wherein in the step of causing the flow portion to become flowable by the input of energy, at least a portion of the energy impinges on the first object until the flow portion becomes flowable, and the flow portion is caused to penetrate into structures of the second object.

14. The method according to claim 13, wherein the structures of the second objects comprise pores of the second objects, wherein the pores are pre-existing pores or pores generated during the step of causing the flow portion to penetrate into the structures of the second object.

15. The method according to claim 13, wherein the first object is a connector or reinforcement element, and the method comprises connecting a further object to the second object via the connector.

16. The method according to claim 1, wherein at least a portion of the energy is coupled into the second object, and material of the first object is caused to flow into pre-made structures of the second object.

17. The method according to claim 16, wherein the second object is a connector or reinforcement element, and the method comprises connecting a further object to the first object via the connector.

18. The method according to claim 1, wherein the second object comprises a thermoplastic material different from the modified compound, and wherein in the step of causing the flow portion to become flowable by the input of energy, near an interface between the first and second objects portions of the thermoplastic material become flowable, resulting in an interpenetration zone between the thermoplastic material and the flow portion.

19. The method according to claim 1, wherein during the step of causing the flow portion to become flowable by the input of energy, the first and second objects are pressed against each other.

20. The method according to claim 1, wherein after the step of allowing the flow portion to re-solidify, the first and second objects are secured to each other by a positive-fit connection in the interpenetration zone.

21. The method according to claim 1, wherein after the step of allowing the flow portion to re-solidify, the flow portion adheres to material of the second object in the interpenetration zone.

22. The method according to claim 1, wherein the first object consists of the hardened article.

23. The method according to claim 1, wherein the hardening process takes place at room temperature or at a temperature the compound reaches when the process takes place without input of thermal energy.

24. The method according to claim 1, wherein the hardening process comprises drying, a chemical reaction, percolation, a hydraulic reaction, or adsorption.

25. The method according to claim 24, wherein the chemical reaction is a curing, especially a polymerization.

26. The method according to claim 1, wherein the flowable compound comprises a solvent a binder and a filling material.

27. The method according to claim 26, wherein the flowable compound comprises further additives.

28. The method according to claim 26, wherein the solvent is water or an aqueous solvent.

29. The method according to claim 26, wherein the binder is a protein glue.

30. The method according to claim 26, wherein the filling material is a natural fiber.

31. The method according to claim 30 wherein the natural fiber is chosen from the group consisting of: wood fibers, cellulose fibers, fibers of corn, bamboo fibers, hemp fibers, fibers made of hazelnut shells, and cotton.

32. The method according to claim 27, wherein the additive is a hygroscopic agent.

33. The method according to claim 32, wherein the hygroscopic agent is chosen from the group consisting of: cellulose, calcium chloride, magnesium chloride, zinc chloride, ferric chloride, carnallite, potassium carbonate, potassium phosphate, ferric ammonium citrate, ammonium nitrate, potassium hydroxide, and sodium hydroxide.

34. Use of a material which comprises or is obtained by mixing together:
10-60% per weight of a binder;
5-50% per weight of a filling material;
2-50% per weight of an additive, and
up to 83% per weight of a solvent
for manufacturing a connector or reinforcement element.

35. A connector or reinforcement element obtained by mixing together:
10-60% per weight of a binder;
5-50% per weight of a filling material;
2-50% per weight of an additive, and
up to 83% per weight of a solvent.

36. The connector or reinforcement element according to claim 35, wherein the connector comprises a surface portion of a material being a modified compound obtained from subjecting the mixture to a hardening process.

37. The connector or reinforcement element according to claim 35, comprising a coupling-in face for receiving mechanical vibration energy, and further comprising an energy director formed of the modified compound.

38. The connector or reinforcement element according to claim 35, comprising a non-liquifiable portion such as a core, the core preferably comprising at least one of natural fibers, wood, a biodegradable material, a metal, ceramic material, a thermosetting polymer or any combination thereof.

39. A method for making a connector or reinforcement element comprising the step of:
mixing together
10-60% per weight of a binder;
5-50% per weight of a filling material;
2-50% per weight of an additive, and
up to 83% per weight of a solvent.

40. The method according to claim 39 further comprising a hardening process.

41. Use of a connector as defined in claim 35, wherein the material of the connector is at least partially liquefied.

42. Use according to claim 41, wherein the liquefaction is caused by mechanical energy transferred to the connectors.
